(19) United States
(12) Patent Application Publication
(10) Pub. No.: US 2018/0268460 A1
(43) Pub. Date: Sep. 20, 2018

(54) METHOD AND APPARATUS FOR INFORMATION RECOMMENDATION

(71) Applicant: Tencent Technology (Shenzhen) Company Limited, Shenzhen (CN)

(72) Inventors: Yue WU, Shenzhen (CN); Peng LIU, Shenzhen (CN)

(21) Appl. No.: 15/985,344

(22) Filed: May 21, 2018

Related U.S. Application Data
(63) Continuation-in-part of application No. PCT/CN2017/072192, filed on Jan. 23, 2017.

(30) Foreign Application Priority Data
Feb. 5, 2016 (CN) 201610081858.4

(51) Int. Cl. G06Q 30/06; G06Q 10/02; G06Q 50/30

(52) U.S. Cl. CPC G06Q 30/0631; G06Q 50/30; G06Q 30/0641; G06Q 10/02

(57) ABSTRACT

The present disclosure relates to an information recommendation method and apparatus. The method is performed at a mobile terminal that is communicatively connected to an information exchange server and also to a public identifier server via the information exchange server and includes obtaining input ticket booking information, the ticket booking information including at least a ticket type and a ticket quantity; generating a tour route obtaining request according to the ticket booking information and identifier information of a to-be-visited spot; sending the tour route obtaining request and a user identifier of a user of the mobile terminal to the information exchange server; and receiving a specified tour route that is from the public identifier server and sent by the information exchange server based on the user identifier and that matches the tour route obtaining request, and displaying the specified tour route on the mobile terminal.

### RELATED APPLICATIONS

This application is a continuation-in-part application of PCT/CN2017/072192, entitled “INFORMATION RECOMMENDATION METHOD AND APPARATUS” filed on Jan. 23, 2017, which claims priority to Chinese Patent Application No. 201610081858.4, filed with the State Intellectual Property Office of the People's Republic of China on Feb. 5, 2016, and entitled “INFORMATION RECOMMENDATION METHOD AND APPARATUS,” all of which are incorporated herein by reference in their entirety.

### FIELD OF THE TECHNOLOGY

The present disclosure relates to the field of network technologies, and in particular, to an information recommendation method and apparatus.

### BACKGROUND OF THE DISCLOSURE

With continuous improvement of living standards, during holidays and festivals, a growing quantity of people choose to visit leisure places such as a scenic resort, an amusement park, a park, and a museum.

At present, after arriving at the foregoing leisure place, a tourist further needs to queue up at a manual ticket window to buy a ticket, and after buying a ticket, the tourist goes into the leisure place from a gate disposed at an entrance to play. During a visit, the tourist generally plays according to a tour route that is customized by the tourist in advance, or wanders aimlessly. For such two visiting manners, in the first visiting manner, the tourist needs to do a lot of preparation work in advance by searching the Internet or the like, which is relatively complex, time-consuming, and labor-consuming; and in the second visiting manner, it is very easy to miss a popular scenic spot or a landmark; consequently, user experience is relatively poor. Therefore, an information recommendation method is urgently needed, so that a tourist can take a tour based on a proper tour route during a visit.

### SUMMARY

To resolve a problem in the existing technology, embodiments of the present disclosure provide an information recommendation method and apparatus. The technical solutions are as follows:

According to a first aspect, an information recommendation method is performed at a mobile terminal that is communicatively connected to an information exchange server and also to a public identifier server via the information exchange server.

The method includes:

obtaining input ticket booking information, the ticket booking information comprising at least a ticket type and a ticket quantity;

generating a tour route obtaining request according to the ticket booking information and identifier information of a to-be-visited spot;

sending the tour route obtaining request and a user identifier of a user of the mobile terminal to the information exchange server; and receiving a specified tour route, which is from the public identifier server and sent by the information exchange server based on the user identifier, and which matches the tour route obtaining request, and displaying the specified tour route on the mobile terminal

According to a second aspect, a mobile terminal is communicatively connected to an information exchange server and also to a public identifier server via the information exchange server. The mobile terminal includes one or more processors; memory coupled to the one or more processors; and a plurality of executable instructions stored in the memory, wherein the executable instructions, when executed by the one or more processors, cause the mobile terminal to perform the aforementioned method.

According to a third aspect, a non-transitory computer readable storage medium storing a plurality of executable instructions configured for execution by one or more processors of a mobile terminal that is communicatively connected to an information exchange server and also to a public identifier server via the information exchange server, wherein the plurality of instructions, when executed by the one or more processors, cause the mobile terminal to perform the aforementioned method.

The technical solutions provided in the exemplary embodiments of the present disclosure have the following beneficial effects:

After ticket booking information that is input by a user in a ticket booking process is obtained, a tour route matching the user is actively obtained from an information exchange server according to the ticket booking information and identifier information of a to-be-visited spot, and the tour route is recommended to the user, which is relatively intelligent, reduces time costs and complexity when the user actively queries for the tour route, and further can prevent the user from missing some popular scenic spots or landmarks, thereby improving user stickiness.

### BRIEF DESCRIPTION OF THE DRAWINGS

To describe the technical solutions in the exemplary embodiments of the present disclosure more clearly, the following briefly describes the accompanying drawings required for describing the exemplary embodiments. Apparently, the accompanying drawings in the following description show merely some embodiments of the present disclosure, and a person of ordinary skill in the art may still derive other drawings from these accompanying drawings without creative efforts.

FIG. 1 is an architectural diagram of a system related to an information recommendation method according to an exemplary embodiment of the present disclosure;

FIG. 2 is a flowchart of an information recommendation method according to an exemplary embodiment of the present disclosure;

FIG. 3 is a flowchart of an information recommendation method according to an exemplary embodiment of the present disclosure;

FIG. 4 is a flowchart of an information recommendation method according to an exemplary embodiment of the present disclosure;

FIG. 5A is a schematic diagram of a display interface on a mobile terminal according to an exemplary embodiment of the present disclosure;

FIG. 5B is a schematic diagram of a display interface on a mobile terminal according to an exemplary embodiment of the present disclosure;

FIG. 5C is a schematic diagram of a display interface on a mobile terminal according to an exemplary embodiment of the present disclosure;

FIG. 5D is a schematic diagram of a display interface on a mobile terminal according to an exemplary embodiment of the present disclosure;

FIG. 5E is a schematic diagram of a display interface on a mobile terminal according to an exemplary embodiment of the present disclosure;

FIG. 5F is a schematic diagram of a display interface on a mobile terminal according to an exemplary embodiment of the present disclosure;

FIG. 5G is a schematic diagram of a display interface on a mobile terminal according to an exemplary embodiment of the present disclosure;

FIG. 5H is a schematic diagram of a display interface on a mobile terminal according to an exemplary embodiment of the present disclosure;

FIG. 6 is a schematic structural diagram of an information recommendation apparatus according to an exemplary embodiment of the present disclosure;

FIG. 7 is a schematic structural diagram of an information recommendation apparatus according to an exemplary embodiment of the present disclosure;

FIG. 8 is a schematic structural diagram of a mobile terminal according to an exemplary embodiment of the present disclosure; and

FIG. 9 is a schematic structural diagram of a server according to an exemplary embodiment of the present disclosure.

### DESCRIPTION OF EMBODIMENTS

To make the objectives, technical solutions, and advantages of the present disclosure clearer, the following further describes the exemplary embodiments of the present disclosure in detail with reference to the accompanying drawings.

Before the exemplary embodiments of the present disclosure are explained and described in detail, some terms that may be used in the exemplary embodiments of the present disclosure are first defined and described.

A public identifier is an application account that is applied for by an operator on an information exchange platform. By means of a public identifier, an operator can implement comprehensive communication or interaction with a particular group based on a text, an image, an audio, a video, or the like on the information exchange platform. An operator is generally an institution or an individual more concerned by a user, for example, a merchant, an enterprise, a government, media, or a celebrity. An information exchange platform is a platform that provides an interface to a third party based on an original software system, and by means of access by the third party, enhances a function of the original software system or uses a resource of the original software system, for example, a WeChat public platform or an Alipay service window platform. An original software system may be an information exchange application system, a payment application system, or another related application system. Using an information exchange application system as an example, after an operator applies for a public identifier on an information exchange platform, a normal registered user in the information exchange application system can follow the public identifier. Then, the normal registered user and the operator can exchange information such as a text, an image, an audio, or a video by using the information exchange application as a medium. In addition, a menu option is further displayed on an information exchange page between the normal registered user and the operator, and a menu style of the menu option may be defined by the operator, and is generated by a third party by invoking an open menu creation interface. For example, three first-level menus may be created, and each first-level menu may include multiple second-level menus and the like. This is not specifically limited in the exemplary embodiments of the present disclosure.

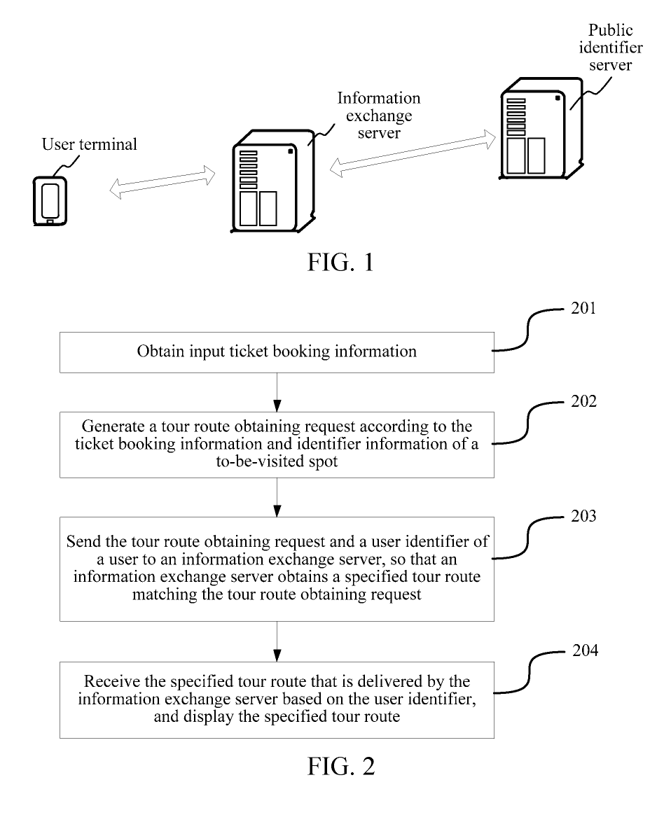

FIG. 1 is an architectural diagram of a system related to an information recommendation method according to an exemplary embodiment of the present disclosure. Referring to FIG. 1, the system includes a mobile terminal, an information exchange server, and a public identifier server. After a normal registered user installs an information exchange application on the mobile terminal, the user may exchange information with a different user, for example, a friend, on a relation chain of the user based on the information exchange application and the information exchange server, release information on a personal presentation page, exchange information with a public identifier, and the like. The public identifier server is configured to manage a public identifier of each operator, store related information of each public identifier, and the like. Using a public identifier of a scenic resort as an example, related information may be an audio commentary of each scenic spot in the scenic resort, an image of the scenic resort, map data of the scenic resort, or the like. This is not specifically limited in this exemplary embodiment of the present disclosure. The related information of each public identifier may be uploaded by the operator to the public identifier server by using an open interface. When the normal registered user interacts with the public identifier, the information exchange server actively obtains the related information of the public identifier from the public identifier server, and displays the related information on an information exchange page between the normal registered user and the public identifier.

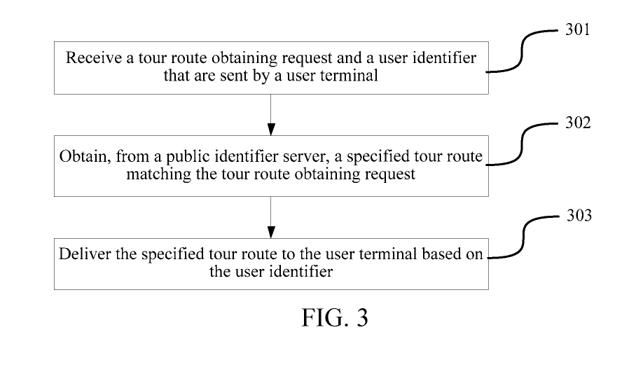

FIG. 2 is a flowchart of an information recommendation method according to an exemplary embodiment of the present disclosure. Referring to FIG. 2, using that a mobile terminal performs the method as an example, a procedure of the method provided in this exemplary embodiment of the present disclosure includes the following steps:

201: Obtain input ticket booking information.

The ticket booking information includes at least a ticket type and a ticket quantity.

202: Generate a tour route obtaining request according to the ticket booking information and identifier information of a to-be-visited spot.

203: Send the tour route obtaining request and a user identifier of a user to an information exchange server, so that an information exchange server obtains a specified tour route matching the tour route obtaining request.

204: Receive the specified tour route that is sent by the information exchange server based on the user identifier, and display the specified tour route.

According to the method provided in this exemplary embodiment of the present disclosure, after ticket booking information that is input by a user in a ticket booking process is obtained, a tour route matching the user is actively obtained from an information exchange server according to the ticket booking information and identifier information of a to-be-visited spot, and the tour route is recommended to the user, which is relatively intelligent, reduces time costs and complexity when the user actively queries for the tour route, and further can prevent the user from missing some popular scenic spots or landmarks, thereby improving user stickiness.

In some embodiments, before the obtaining input ticket booking information, the method further includes:

sending an access request for a ticket booking link to the information exchange server, so that the information exchange server obtains web page information corresponding to the ticket booking link, where the ticket booking link is obtained by scanning a graphic code of the to-be-visited spot by a mobile terminal; and

receiving the web page information sent by the information exchange server, and displaying a ticket booking page based on the web page information.

In some embodiments, before the obtaining input ticket booking information, the method further includes:

after detecting an operation of selecting a ticket booking menu option on a first information exchange page, sending an access request for a ticket booking link to the information exchange server, so that the information exchange server obtains web page information corresponding to the ticket booking link, where the first information exchange page is a page related to the to-be-visited spot and including multiple levels of menu options; and

receiving the web page information sent by the information exchange server, and displaying a ticket booking page based on the web page information.

In some embodiments, before the obtaining input ticket booking information, the method further includes:

after detecting an operation of tapping a ticket booking link on a second information exchange page, sending an access request for the ticket booking link to the information exchange server, so that the information exchange server obtains web page information corresponding to the ticket booking link, where the second information exchange page is a page on which the user exchanges information with a friend; and

receiving the web page information sent by the information exchange server, and displaying a ticket booking page based on the web page information.

In some embodiments, after the obtaining input ticket booking information, the method further includes:

sending a map data obtaining request to the information exchange server, where the map data obtaining request includes at least the identifier information of the to-be-visited spot, so that the information exchange server obtains map data matching the to-be-visited spot;

receiving the map data sent by the information exchange server; and

after detecting a map guide operation that is performed by the user by using an information exchange application, displaying map information in a preset geographic range on a map interface based on the map data and a current geographic location of the user.

In some embodiments, the map interface includes multiple point of interest filtering options, and the displaying map information in a preset geographic range on a map interface includes:

after detecting an operation of selecting one point of interest filtering option, displaying, on the map interface, at least one point of interest that is in the preset geographic range and that matches the point of interest filtering option; and

after detecting an operation of selecting any one of the at least one point of interest, displaying detailed description information of the point of interest and navigation information of a path to the point of interest.

In some embodiments, after the obtaining input ticket booking information, the method further includes:

after detecting an audio commentary operation that is performed by the user by using an information exchange application, displaying, on a first information exchange page, introduction information of an audio commentary matching the to-be-visited spot; and

after receiving an audio commentary request of the user for any point of interest in the to-be-visited spot, sending an audio commentary obtaining request to the information exchange server, where the audio commentary obtaining request includes at least identifier information of the point of interest, so that the information exchange server obtains an audio commentary matching the point of interest; and

receiving the audio commentary sent by the information exchange server, and broadcasting the audio commentary.

An optional embodiment of the present disclosure may be formed by using any combination of all the foregoing optional technical solutions, and details are not described herein.

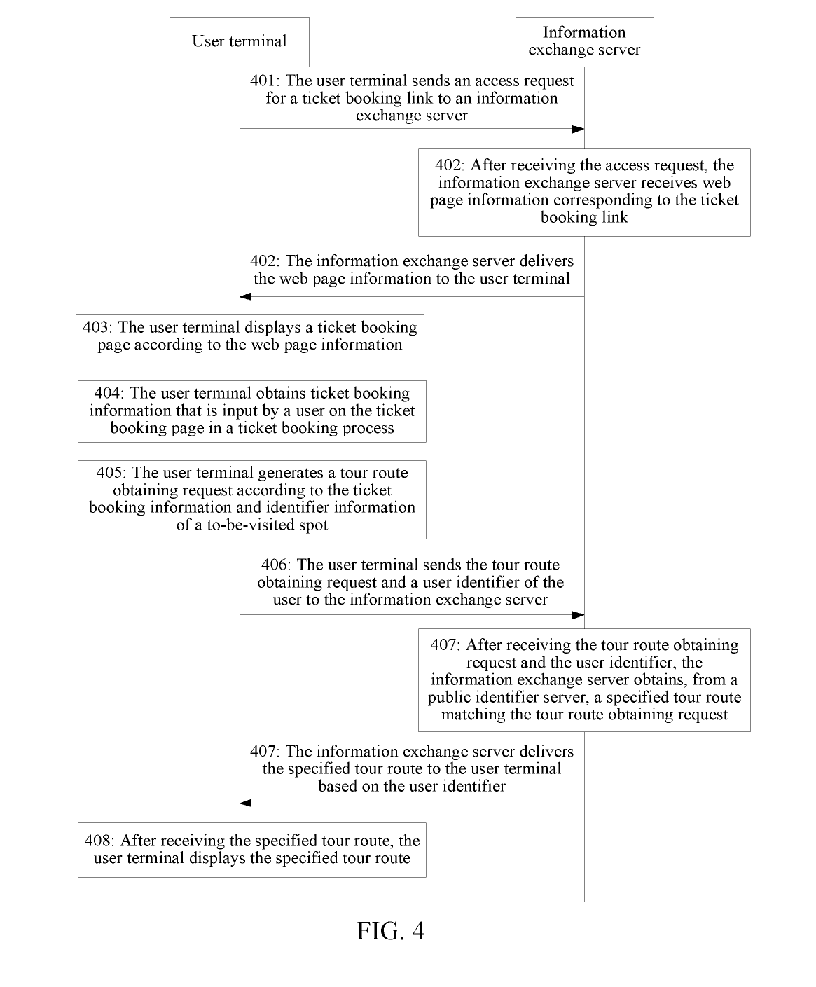

FIG. 3 is a flowchart of an information recommendation method according to an exemplary embodiment of the present disclosure. Referring to FIG. 3, using that an information exchange server performs the method as an example, a procedure of the method provided in this exemplary embodiment of the present disclosure includes the following steps:

301: Receive a tour route obtaining request and a user identifier that are sent by a user mobile terminal.

The tour route obtaining request includes at least ticket booking information that is input by a user in a ticket booking process and identifier information of a to-be-visited spot, and the ticket booking information includes at least a ticket type and a ticket quantity.

302: Obtain, from a public identifier server, a specified tour route matching the tour route obtaining request.

303: Send the specified tour route to the user mobile terminal based on the user identifier.

The public identifier server being a server for managing a specified public identifier of the to-be-visited spot, and storing related information of the specified public identifier.

According to the method provided in this exemplary embodiment of the present disclosure, after obtaining ticket booking information that is input by a user in a ticket booking process, a user mobile terminal actively generates a tour route obtaining request according to the ticket booking information and identifier information of a to-be-visited spot, and sends the tour route obtaining request to an information exchange server; and the information exchange server sends a tour route matching the user to the user mobile terminal according to the tour route obtaining request, to recommend the tour route to the user. Such a visiting manner is more intelligent, reduces time costs and complexity when the user actively queries for the tour route, and further can prevent the user from missing some popular scenic spots or landmarks.

In some embodiments, before the receiving a tour route obtaining request that is sent by a user mobile terminal, the method further includes:

receiving an access request for a ticket booking link that is sent by the user mobile terminal; and

obtaining web page information corresponding to the ticket booking link, and sending the web page information to the user mobile terminal.

The access request is obtained by scanning a graphic code of the to-be-visited spot by the user mobile terminal, or the access request is sent by the user mobile terminal after the user mobile terminal detects an operation of selecting a ticket booking menu option on a first information exchange page, where the first information exchange page is a page related to the to-be-visited spot and including multiple levels of menu options; or the access request is sent by the user mobile terminal after the user mobile terminal detects an operation of tapping the ticket booking link on a second information exchange page, where the second information exchange page is a page on which the user exchanges information with a friend.

In some embodiments, the method further includes:

receiving a map data obtaining request sent by the user mobile terminal, where the map data obtaining request includes at least the identifier information of the to-be-visited spot; and

obtaining map data matching the to-be-visited spot from the public identifier server, and sending the map data to the user mobile terminal.

In some embodiments, the method further includes:

receiving an audio commentary obtaining request sent by the mobile terminal, where the audio commentary obtaining request includes at least identifier information of any point of interest in the to-be-visited spot; and

obtaining an audio commentary matching the point of interest from the public identifier server, and sending the audio commentary to the mobile terminal.

An optional embodiment of the present disclosure may be formed by using any combination of all the foregoing optional technical solutions, and details are not described herein.

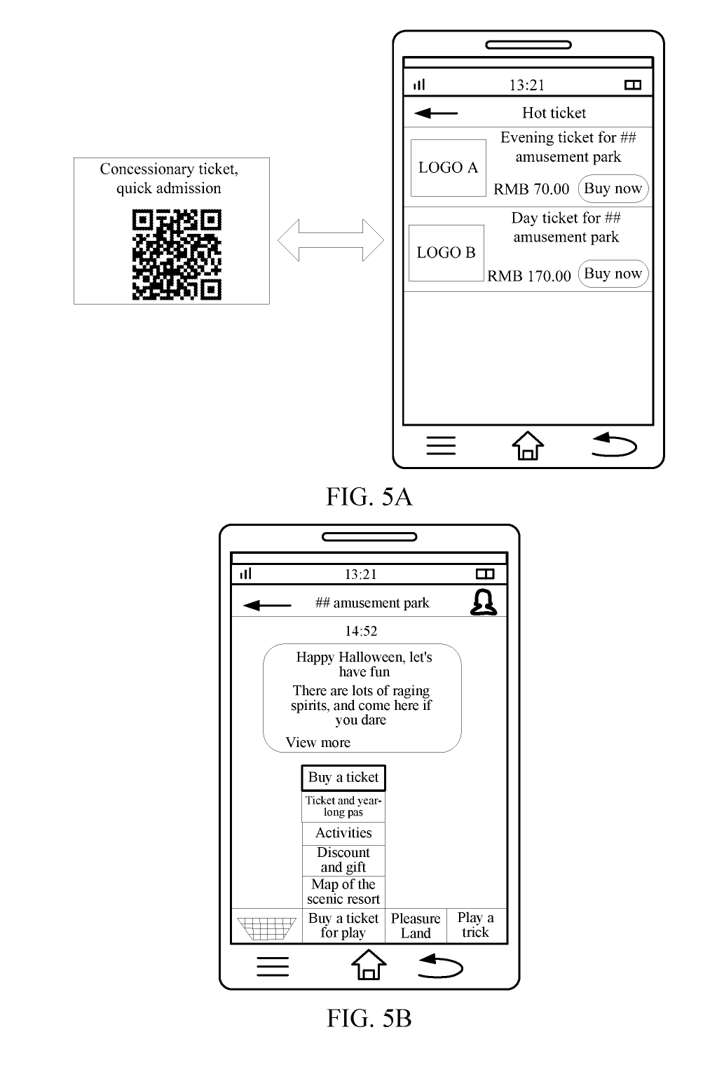

FIG. 4 is a flowchart of an information recommendation method according to an exemplary embodiment of the present disclosure. A mobile terminal interacts with an information exchange server. Referring to FIG. 4, a procedure of the method provided in this exemplary embodiment of the present disclosure includes the following steps:

401: A mobile terminal sends an access request for a ticket booking link to an information exchange server.

Nowadays, for most tour spots such as a scenic resort, an amusement park, and a museum, a ticket needs to be bought for a visit. In a traditional ticket booking manner, a user needs to queue up at a ticket window disposed at an entrance of a to-be-visited spot to buy a paper ticket and then goes into the to-be-visited spot. In this exemplary embodiment of the present disclosure, to relieve ticket booking pressure and save a time of a user, the following three electronic ticket booking manners that are relatively intelligent and convenient are provided.

In the first manner, a graphic code is disposed at an entrance of a tour spot, and a user buys a ticket by scanning the graphic code.

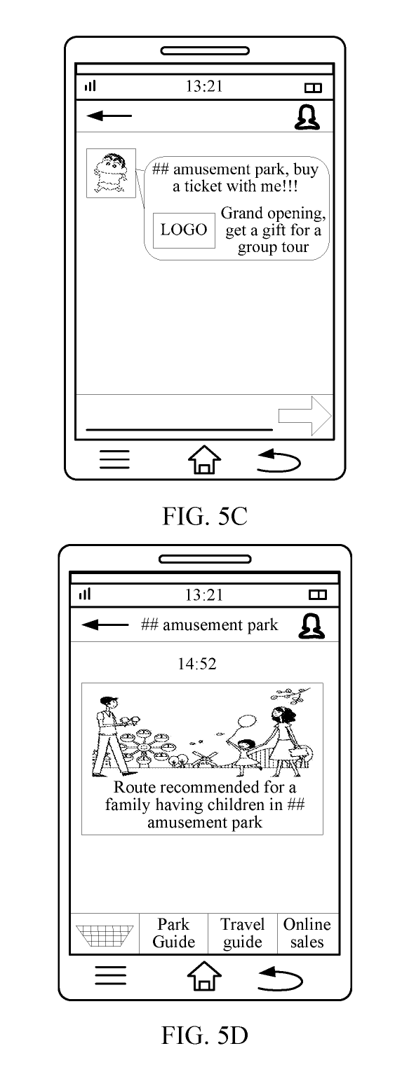

In the first manner, the graphic code is preferably a two-dimensional code. Tickets for sale are generally classified into multiple ticket types such as a child ticket, a senior ticket, and an adult ticket. During generation of a graphic code, a two-dimensional code may be generated for each ticket type, and the two-dimensional code for each ticket type may be disposed at the entrance. The user may scan a corresponding two-dimensional code to buy a corresponding ticket. In addition, a uniform two-dimensional code may be generated for all ticket types, and subsequently, the user scans the two-dimensional code to enter a ticket booking page, and then selects a ticket type to be bought on the ticket booking page. A specific manner to use is not specifically limited in this exemplary embodiment of the present disclosure. In this exemplary embodiment of the present disclosure, an example in which a uniform two-dimensional code is generated is used for description. As shown in FIG. 5A, after the user scans a two-dimensional code for ticket booking by using a code scanning function provided by an information exchange application, the mobile terminal is triggered to send an access request for a ticket booking link to the information exchange server, to obtain a ticket booking page shown in FIG. 5A.

In the second manner, the user follows a public identifier of a to-be-visited spot, and then buys a ticket by tapping a ticket booking menu option on a first information exchange page.

In the second manner, if an operator of the to-be-visited spot applies for the public identifier on an information exchange platform, and provides a menu option for ticket booking, a ticket can be directly bought by using the public identifier. The first information exchange page is a page entered after the user follows the public identifier. As shown in FIG. 5B, the operator of the to-be-visited spot may send a push notification and the like to the user on the first information exchange page. Multiple first-level menu options are provided on the first information exchange page, for example, a menu option with characters “Buy a ticket for play” is displayed. After the user taps the menu option, multiple second-level menu options are displayed, as shown in FIG. 5B. The second-level menu options include a ticket booking menu option “Buy a ticket”. After detecting an operation of selecting the ticket booking menu option, the mobile terminal sends an access request for a ticket booking link to the information exchange server.

In the third manner, the user receives a ticket booking link of a to-be-visited spot that is sent by a friend on a relation chain of the user.

In the third manner, because nowadays, an information exchange application provides a sharing function, after the friend buys a ticket online, the friend may share the ticket booking link with the user by using the information exchange application, as shown in FIG. 5C. After receiving the ticket booking link on a second information exchange page, the user may directly tap the ticket booking link to buy a ticket. Based on the second information exchange page, the user may exchange information such as a text, an image, or a video with the friend.

402: After receiving the access request, the information exchange server obtains web page information corresponding to the ticket booking link, and sends the web page information to the mobile terminal.

In this exemplary embodiment of the present disclosure, after receiving the access request for the ticket booking link, the information exchange server may obtain, from an operation server or an operation mobile terminal of the to-be-visited spot by using an open interface, the web page information corresponding to the ticket booking link, and sends the web page information to the mobile terminal, to facilitate rendering the ticket booking page by the mobile terminal according to the web page information.

403: The mobile terminal displays a ticket booking page according to the web page information.

After receiving the web page information, the mobile terminal may render the ticket booking page according to the web page information in a page rendering manner, and displays the ticket booking page by using the information exchange application. As shown in FIG. 5A, the ticket booking page may include a current hot ticket type, a logo of the to-be-visited spot, a ticket fare, and the like. For example, after the user taps an option “Buy now”, page switching is performed, and a ticket booking detail page is switched to. The user may manually select a ticket type and a ticket quantity on the ticket booking detail page. After the mobile terminal detects a payment confirmation operation on the ticket booking detail page, page switching is performed again, and a payment page is switched to. The user pays for the ticket to the to-be-visited spot under guidance of the payment page. After detecting that the user has made a successful payment, the information exchange server sends an electronic ticket to the mobile terminal by using the information exchange application or by using an SMS message. The electronic ticket may be in a form of a two-dimensional code, a bar code, a collection code, or the like. This is not specifically limited in this exemplary embodiment of the present disclosure.

It should be noted that, after the user successfully buys the ticket, to improve user experience, this exemplary embodiment of the present disclosure further provides steps of recommending a proper tour route to the user based on the ticket booking information of the user. Details are as follows:

404: The mobile terminal obtains ticket booking information that is input by a user on the ticket booking page in a ticket booking process.

The ticket booking information includes at least a ticket type and a ticket quantity. The ticket type may include a child ticket, an adult ticket, a solider ticket, a senior ticket, a disability ticket, or the like. This is not specifically limited in this exemplary embodiment of the present disclosure. In some embodiments, pull-down options related to the ticket type and the ticket quantity may be provided on the ticket booking page, and the user may select the ticket type to be bought and the ticket quantity by using the pull-down options.

405: The mobile terminal generates a tour route obtaining request according to the ticket booking information and identifier information of a to-be-visited spot.

The identifier information of the to-be-visited spot may be a name, an image, a code, or the like of the to-be-visited spot. This is not specifically limited in this exemplary embodiment of the present disclosure.

406: The mobile terminal sends the tour route obtaining request and a user identifier of the user to the information exchange server.

The user identifier may be an avatar, a nickname, or the like that is used by the user after the user logs in to the information exchange application. This is not specifically limited in this exemplary embodiment of the present disclosure.

407: After receiving the tour route obtaining request and the user identifier, the information exchange server obtains, from a public identifier server, a specified tour route matching the tour route obtaining request, and sends the specified tour route to the mobile terminal based on the user identifier.

In this exemplary embodiment of the present disclosure, for a tour spot, usually, a great quantity of scenic spots may be covered in the tour spot, to meet requirements of groups of different ages. Therefore, for groups of different ages, in consideration of factors such as a time and physical strength, in a limited time and with limited energy, usually, scenic spots in the to-be-visited spot are not all visited. Certainly, during a visit, it is also a loss for the user if the user misses a popular scenic spot or a landmark. Therefore, this exemplary embodiment of the present disclosure provides a manner of recommending a tour route to the user based on the ticket booking information of the user. For example, if the user buys two adult tickets, a lovers' tour route is recommended to the user in priority. If the user buys a child ticket, a family tour route is recommended to the user in priority. If the user buys a senior ticket, a leisure tour route is recommended to the user in priority. If the user buys multiple adult tickets, a group tour route is recommended to the user in priority. In addition, if the user buys multiple tickets and ticket quantities for all ticket types have a small difference, multiple tour routes may be recommended to the user. For example, if the user buys 10 tickets including six adult tickets and four senior tickets, a hot tour route or a tour route with a landmark, and a leisure tour route may be recommended to the user at the same time.

It should be noted that, when the tour route is recommended to the user, user attribute information may further be obtained according to the user identifier of the user, and the tour route is recommended to the user with reference to the ticket booking information and the user attribute information. Different tour routes may be customized by the operator of the to-be-visited spot, uploaded to the public identifier server by using an open interface, and stored by the public identifier server. In this way, after receiving the tour route obtaining request, the information exchange server may directly obtain the corresponding tour route from the public identifier server.

408: After receiving the specified tour route, the mobile terminal displays the specified tour route.

In this exemplary embodiment of the present disclosure, after the user receives the specified tour route, title information and the like of the specified tour route may be directly displayed on the first information exchange page, as shown in FIG. 5D. After the user taps a box of the title information, detailed information of the specified tour route is displayed, for example, a name or an image of each point of interest. This is not specifically limited in this exemplary embodiment of the present disclosure.

It should be noted that, in this exemplary embodiment of the present disclosure, in addition to recommending the tour route during a visit of the user, map guide and audio commentary services are further provided. Detailed processes are as follows:

For a map guide function, to help the user to learn a map of a scenic resort in time, the mobile terminal may further pre-download an offline map data packet of the to-be-visited spot. A specific process is: sending, by the mobile terminal, a map data obtaining request to the information exchange server, where the map data obtaining request includes at least the identifier information of the to-be-visited spot, so that the information exchange server obtains map data matching the to-be-visited spot. After receiving the map data returned by the information exchange server, the mobile terminal may first store the map data, for subsequent use.

As shown in FIG. 5B, for example, a menu option “Map of the scenic resort” is displayed on the first information exchange page. If the menu option is tapped, a map guide operation is triggered, that is, the mobile terminal detects the map guide operation that is performed by the user by using the information exchange application. Afterwards, as shown in FIG. 5E, the mobile terminal displays map information in a preset geographic range on a map interface based on the stored map data and a current geographic location of the user. The preset geographic range may be a range of a few hundred meters to few thousand meters around centered on the current location of the user. This is not specifically limited in this exemplary embodiment of the present disclosure. The current location of the user is asterisked.

In another embodiment, to help the user to rapidly lock a point of interest of a particular type, to leave for the point of interest of the type as soon as possible, as shown in FIG. 5E, the map interface further includes multiple point of interest filtering options. The point of interest filtering options may include a rest area, a place providing access to a wireless network, a washroom, a dining area, a place providing a bus, a scenic spot, a shop, a convenience store, and the like. This is not specifically limited in this exemplary embodiment of the present disclosure. In addition, besides displaying the multiple point of interest filtering options in a form of images, the multiple point of interest filtering options may further be displayed in a form of texts. This is not specifically limited in this exemplary embodiment of the present disclosure. In this way, when the map information in the preset geographic range is displayed on the map interface, the following manner may be used for implementation:

After an operation of selecting one point of interest filtering option is detected, at least one point of interest that is in the preset geographic range and that matches the point of interest filtering option is displayed on the map interface; and after an operation of selecting any one of the at least one point of interest is detected, detailed description information of the point of interest and navigation information of a path to the point of interest are displayed.

Referring to FIG. 5E, after the user choose to display a point of interest filtering option corresponding to a scenic spot in the to-be-visited spot, information about all scenic spots in the preset geographic range are displayed by using bubbles on the map interface, to remind the user. Certainly, in addition to displaying by using bubbles, another manner may be used for display, for example, a red dot mark may be used for display. This is not specifically limited in this exemplary embodiment of the present disclosure. In addition, to better display the map, the point of interest filtering option may be hidden according to a page hiding operation performed by the user. For example, after a tap operation performed by the user on a blank area on the map interface is detected, or a pull-down operation performed by the user in an area of the point of interest filtering option is detected, the point of interest filtering option is hidden, and then, a complete map interface shown in FIG. 5F is displayed. Because a location of each scenic spot is shown on the map interface, after a tap operation performed by the user on any one of the scenic spots obtained by filtering in FIG. 5E is detected, detailed description information of the point of interest is displayed in a form of a message box around the location of the scenic spot. The detailed description information may include a brief history, detailed location information, a ticket fare, and the like of the scenic spot. For example, as shown in FIG. 5F, for example, detailed description information “The ancestral home of ***, representing life scenes of *** in childhood and located in No. 369, Lao Dong Road. Joint ticket priced at RMB 40” may be displayed. Further, the path navigation information is used to indicate a route from the current location of the user to the scenic spot. The path navigation information and the detailed description information may be displayed on the current map interface. For example, on the current map interface, a bold line in red, blue, or the like is used to display information about the route from the current location of the user to the scenic spot. In addition, the path navigation information and the detailed description information may be displayed on two pages. For example, after the user taps a navigation key on the current map interface, the mobile terminal switches to a path navigation page from the current map interface, and displays the path navigation information on the path navigation page. This is not specifically limited in this exemplary embodiment of the present disclosure.

In an audio commentary process, a menu option such as “Commentary of the scenic resort” may be displayed on the first information exchange page. If the menu option is tapped, an audio commentary request operation is triggered, that is, the mobile terminal detects the audio commentary operation that is performed by the user by using the information exchange application. After detecting the audio commentary operation that is performed by the user by using the information exchange application, as shown in FIG. 5G, the mobile terminal displays introduction information of an audio commentary matching the to-be-visited spot on the first information exchange page. The introduction information includes at least identifier information of each scenic spot, and the identifier information may include a name, a code, or the like of the scenic spot. This is not specifically limited in this exemplary embodiment of the present disclosure. The user may input, on the first information exchange page by means of a manual writing operation, identifier information of a scenic spot that requires a commentary; or may input, on the first information exchange interface by means of a voice recording operation, identifier information of a scenic spot that requires a commentary. This is not specifically limited in this exemplary embodiment of the present disclosure. For example, as shown in FIG. 5H, the user inputs, by using a voice, the identifier information of the scenic spot that requires a commentary.

After receiving an audio commentary request of the user for any scenic spot in the to-be-visited spot, the mobile terminal sends an audio commentary obtaining request to the information exchange server. The audio commentary obtaining request includes at least identifier information of the scenic spot. After receiving the audio commentary request, the information exchange server obtains, from the public identifier server, an audio commentary matching the scenic spot that is prestored by the operator of the to-be-visited spot. Then, the information exchange server sends the audio commentary to the mobile terminal. After receiving the audio commentary sent by the information exchange server, as shown in FIG. 5H, the mobile terminal displays related prompt information on the first information exchange page, to prompt the user for whether to perform voice broadcast. After detecting a broadcast confirmation operation performed by the user, the mobile terminal invokes a built-in speaker device to broadcast the received audio commentary.

According to the method provided in this exemplary embodiment of the present disclosure, after obtaining ticket booking information that is input by a user in a ticket booking process, a mobile terminal actively generates a tour route obtaining request according to the ticket booking information and identifier information of a to-be-visited spot, and sends the tour route obtaining request to an information exchange server; and the information exchange server sends a tour route matching the user to the mobile terminal according to the tour route obtaining request, to recommend the tour route to the user. Such a visiting manner is more intelligent, reduces time costs and complexity when the user actively queries for the tour route, and further can prevent the user from missing some popular scenic spots or landmarks. In addition, besides recommending the tour route to the user, map guide in the visited spot and an audio commentary service for the scenic spot can further be provided. Therefore, such an information recommendation manner is more diversified and brings great convenience to the user, so that tour experience of the user is better.

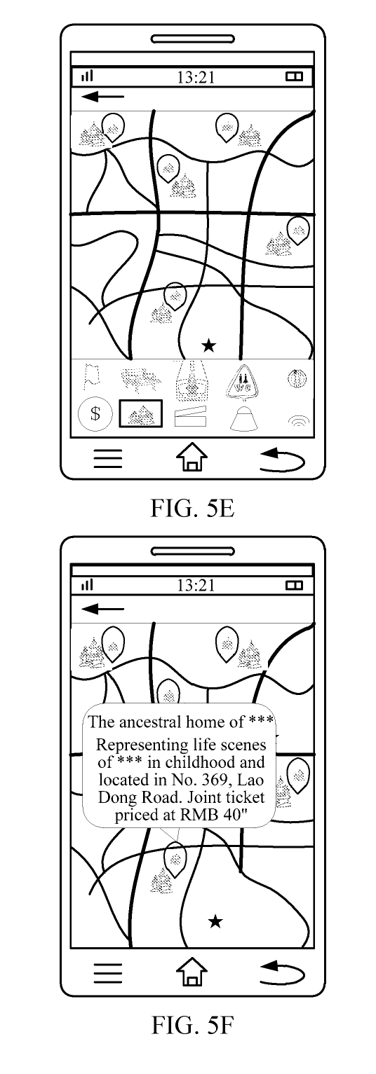

FIG. 6 is a schematic structural diagram of an information recommendation apparatus according to an exemplary embodiment of the present disclosure. Referring to FIG. 6, the apparatus includes an obtaining module 601, a generation module 602, a sending module 603, a receiving module 604, and a display module 605.

The obtaining module 601 is configured to obtain input ticket booking information, the ticket booking information including at least a ticket type and a ticket quantity. The generation module 602 is configured to generate a tour route obtaining request according to the ticket booking information and identifier information of a to-be-visited spot. The sending module 603 is configured to send the tour route obtaining request and a user identifier of a user to an information exchange server, so that an information exchange server obtains a specified tour route matching the tour route obtaining request. The receiving module 604 is configured to receive the specified tour route that is sent by the information exchange server based on the user identifier. The display module 605 is configured to display the specified tour route.

In some embodiments, the sending module 603 is further configured to send an access request for a ticket booking link to the information exchange server, so that the information exchange server obtains web page information corresponding to the ticket booking link, where the ticket booking link is obtained by scanning a graphic code of the to-be-visited spot by a mobile terminal;

the receiving module 604 is further configured to receive web page information sent by the information exchange server; and

the display module 605 is further configured to display a ticket booking page based on the web page information.

In some embodiments, the sending module 603 is further configured to: after an operation of selecting a ticket booking menu option on a first information exchange page is detected, send an access request for a ticket booking link to the information exchange server, so that the information exchange server obtains web page information corresponding to the ticket booking link, where the first information exchange page is a page related to the to-be-visited spot and including multiple levels of menu options;

the receiving module 604 is further configured to receive web page information sent by the information exchange server; and

the display module 605 is further configured to display a ticket booking page based on the web page information.

In some embodiments, the sending module 603 is further configured to: after an operation of tapping a ticket booking link on a second information exchange page is detected, send an access request for the ticket booking link to the information exchange server, so that the information exchange server obtains web page information corresponding to the ticket booking link, where the second information exchange page is a page on which the user exchanges information with a friend;

the receiving module 604 is further configured to receive web page information sent by the information exchange server; and the display module 605 is further configured to display a ticket booking page based on the web page information.

In some embodiments, the sending module 603 is further configured to send a map data obtaining request to the information exchange server, where the map data obtaining request includes at least the identifier information of the to-be-visited spot, so that the information exchange server obtains map data matching the to-be-visited spot;

the receiving module 604 is further configured to receive the map data sent by the information exchange server; and

the display module 605 is further configured to: after a map guide operation that is performed by the user by using an information exchange application is detected, display map information in a preset geographic range on a map interface based on the map data and a current geographic location of the user.

In some embodiments, the display module 605 is further configured to: after an operation of selecting one point of interest filtering option is detected, display, on the map interface, at least one point of interest that is in the preset geographic range and that matches the point of interest filtering option; and after an operation of selecting any one of the at least one point of interest is detected, display detailed description information of the point of interest and navigation information of a path to the point of interest.

In some embodiments, the display module 605 is further configured to: after an audio commentary operation that is performed by the user by using an information exchange application is detected, display, on a first information exchange page, introduction information of an audio commentary matching the to-be-visited spot;

the sending module 603 is further configured to: after an audio commentary request of the user for any point of interest in the to-be-visited spot is received, send an audio commentary obtaining request to the information exchange server, where the audio commentary obtaining request includes at least identifier information of the point of interest, so that the information exchange server obtains an audio commentary matching the point of interest; and

the receiving module 604 is further configured to the audio commentary sent by the information exchange server.

In this case, the apparatus further includes a broadcast module, configured to broadcast the audio commentary.

After obtaining ticket booking information that is input by a user in a ticket booking process, the apparatus provided in this exemplary embodiment of the present disclosure actively generates a tour route obtaining request according to the ticket booking information and identifier information of a to-be-visited spot, and sends the tour route obtaining request to an information exchange server; and the information exchange server sends a tour route matching the user to the mobile terminal according to the tour route obtaining request, to recommend the tour route to the user. Such a visiting manner is more intelligent, reduces time costs and complexity when the user actively queries for the tour route, and further can prevent the user from missing some popular scenic spots or landmarks. In addition, besides recommending the tour route to the user, map guide in the visited spot and an audio commentary service for the scenic spot can further be provided. Therefore, such an information recommendation manner is more diversified and brings great convenience to the user, so that tour experience of the user is better.

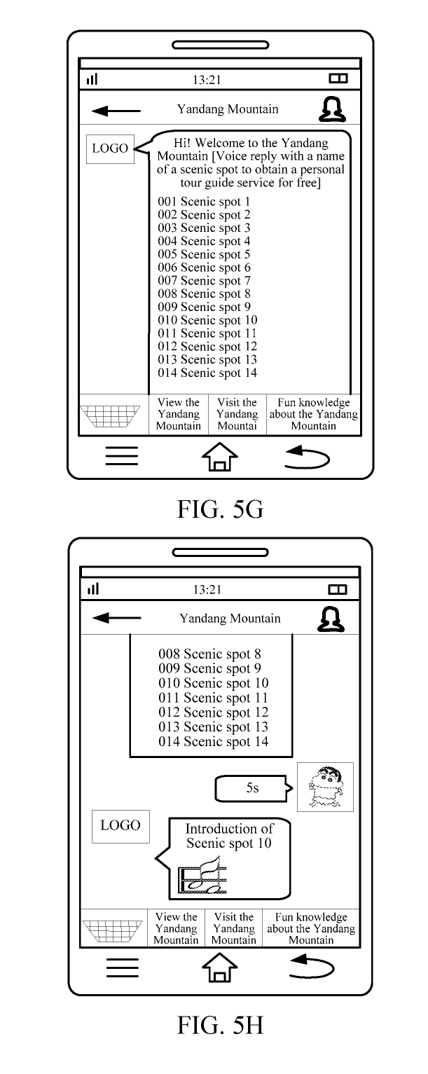

FIG. 7 is a schematic structural diagram of an information recommendation apparatus according to an exemplary embodiment of the present disclosure. Referring to FIG. 7, the apparatus includes: a receiving module 701, an obtaining module 702, and a sending module 703.

The receiving module 701 is configured to receive a tour route obtaining request and a user identifier that are sent by a mobile terminal, the tour route obtaining request including at least ticket booking information that is input by a user in a ticket booking process and identifier information of a to-be-visited spot, and the ticket booking information including at least a ticket type and a ticket quantity. The obtaining module 702 is configured to obtain, from a public identifier server, a specified tour route matching the tour route obtaining request. The sending module 703 is configured to send the specified tour route to the mobile terminal based on the user identifier. The public identifier server being a server for managing a specified public identifier of the to-be-visited spot, and storing related information of the specified public identifier.

In some embodiments, the receiving module 701 is further configured to receive an access request for a ticket booking link that is sent by the mobile terminal;

the obtaining module 702 is further configured to obtain web page information corresponding to the ticket booking link; and

the sending module 703 is further configured to send the web page information to the mobile terminal.

The access request is obtained by scanning a graphic code of the to-be-visited spot by the mobile terminal, or the access request is sent by the mobile terminal after the mobile terminal detects an operation of selecting a ticket booking menu option on a first information exchange page, where the first information exchange page is a page related to the to-be-visited spot and including multiple levels of menu options; or the access request is sent by the mobile terminal after the mobile terminal detects an operation of tapping the ticket booking link on a second information exchange page, where the second information exchange page is a page on which the user exchanges information with a friend.

In some embodiments, the receiving module 701 is further configured to receive a map data obtaining request sent by the mobile terminal, where the map data obtaining request includes at least the identifier information of the to-be-visited spot;

the obtaining module 702 is further configured to obtain map data matching the to-be-visited spot from the public identifier server; and

the sending module 703 is further configured to send the map data to the mobile terminal.

In some embodiments, the receiving module 701 is further configured to receive an audio commentary obtaining request sent by the mobile terminal, where the audio commentary obtaining request includes at least identifier information of any point of interest in the to-be-visited spot;

the obtaining module 702 is further configured to obtain an audio commentary matching the point of interest from the public identifier server; and

the sending module 703 is further configured to send the audio commentary to the mobile terminal.

According to the apparatus provided in this exemplary embodiment of the present disclosure, after obtaining ticket booking information that is input by a user in a ticket booking process, a mobile terminal actively generates a tour route obtaining request according to the ticket booking information and identifier information of a to-be-visited spot, and sends the tour route obtaining request to an information exchange server; and the information exchange server sends a tour route matching the user to the mobile terminal according to the tour route obtaining request, to recommend the tour route to the user. Such a visiting manner is more intelligent, reduces time costs and complexity when the user actively queries for the tour route, and further can prevent the user from missing some popular scenic spots or landmarks. In addition, besides recommending the tour route to the user, map guide in the visited spot and an audio commentary service for the scenic spot can further be provided. Therefore, such an information recommendation manner is more diversified and brings great convenience to the user, so that tour experience of the user is better.

It should be noted that, when the information recommendation apparatus provided in the foregoing embodiment performs information recommendation, only divisions of the foregoing functional modules are described by using an example. During actual application, the foregoing functions may be allocated to and completed by different functional modules according to requirements, that is, the internal structure of the apparatus is divided into different functional modules, to complete all or some of the foregoing described functions. In addition, the information recommendation apparatus provided in the foregoing embodiment belongs to the same concept as the exemplary embodiment of the information recommendation method. For a specific implementation process of the apparatus, refer to the method embodiment, and details are not described herein again.

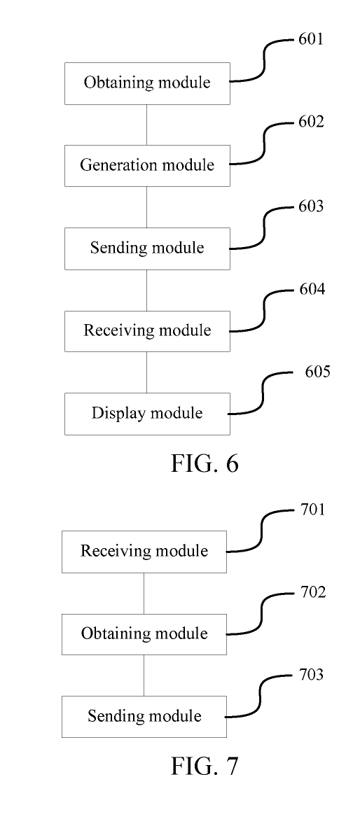

FIG. 8 shows a mobile terminal according to an exemplary embodiment of the present disclosure. The mobile terminal may be configured to perform the information recommendation method performed by a mobile terminal and provided in the foregoing embodiment. Referring to FIG. 8, the mobile terminal 800 includes: components such as a radio frequency (RF) circuit 110, a memory 120 including one or more computer-readable storage mediums, an input unit 130, a display unit 140, a sensor 150, an audio circuit 160, a wireless fidelity (WiFi) module 170, a processor 180 including one or more processing cores, and a power supply 190. A person skilled in the art may understand that the structure of the mobile terminal shown in FIG. 8 does not constitute a limitation to the mobile terminal, and the mobile terminal may include more components or fewer components than those shown in the figure, or some components may be combined, or a different component deployment may be used.

The RF circuit 110 may be configured to receive and send signals during information receiving and sending or during a call. Particularly, the RF circuit 110 receives downlink information from a base station, then delivers the downlink information to one or more processors 180 for processing, and sends related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may further communicate with a network and another device by means of wireless communication. The wireless communication may use any communications standard or protocol, which includes, but is not limited to, a Global System for Mobile communications (GSM), a general packet radio service (GPRS), Code Division Multiple Access (CDMA), Wideband Code Division Multiple Access (WCDMA), Long Term Evolution (LTE), an email, Short Messaging Service (SMS), and the like.

The memory 120 may be configured to store a software program and module. The processor 180 runs the software program and module stored in the memory 120, thereby implementing various function applications and data processing. The memory 120 may mainly include a program storage area and a data storage area. The program storage area may store an operating system, an application program required by at least one function (such as a sound playback function and an image display function), and the like. The data storage area may store data (such as audio data and an address book) created according to use of the mobile terminal 800, and the like. In addition, the memory 120 may include a high-speed random access memory, and may further include a non-volatile memory such as at least one disk storage device, a flash memory, or another volatile solid-state storage device. Correspondingly, the memory 120 may further include a memory controller for the processor 180 and the input unit 130 to access the memory 120. In general, the memory 120 corresponds to a non-transitory computer readable storage medium including volatile and non-volatile media, and removable and non-removable media implemented by using any method or technology used for storing information such as a computer readable instruction, a data structure, a program module or other data. The computer readable storage medium includes a RAM, a ROM, an EPROM, an EEPROM, a flash memory or other solid storage technologies; a CD-ROM, a DVD or other optical storages; and a cassette, a magnetic tape, a disk storage or other magnetic storage devices.

The input unit 130 may be configured to receive input digit or character information, and generate a keyboard, mouse, joystick, optical, or track ball signal input related to the user setting and function control. Specifically, the input unit 130 may include a touch-sensitive surface 131 and another input device 132. The touch-sensitive surface 131, which may also be referred to as a touchscreen or a touch panel, may collect a touch operation of a user on or near the touch-sensitive surface 131 (such as an operation of a user on the touch-sensitive surface 131 or near the touch-sensitive surface 131 by using any suitable object or accessory, such as a finger or a stylus), and drive a corresponding connection apparatus according to a preset program. In some embodiments, the touch-sensitive surface 131 may include two parts: a touch detection apparatus and a touch controller. The touch detection apparatus detects a touch location of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be a resistive, capacitive, infrared, or surface sound wave type touch-sensitive surface 131. In addition to the touch-sensitive surface 131, the input unit 130 may further include the another input device 132. Specifically, the another input device 132 may include, but is not limited to: one or more of a physical keyboard, a functional key (such as a volume control key or a switch key), a track ball, a mouse, and a joystick.

The display unit 140 may be configured to display information input by the user or information provided for the user, and various graphical user interfaces of the mobile terminal 800. The graphical user interfaces may be formed by a graph, a text, an icon, a video, or any combination thereof. The display unit 140 may include a display panel 141. In some embodiments, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the type of the touch event. Then, the processor 180 provides a corresponding visual output on the display panel 141 according to the type of the touch event. Although, in FIG. 8, the touch-sensitive surface 131 and the display panel 141 are used as two separate components to implement input and output functions, in some embodiments, the touch-sensitive surface 131 and the display panel 141 may be integrated to implement the input and output functions.

The mobile terminal 800 may further include at least one sensor 150, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the mobile terminal 800 is moved to the ear. As one type of motion sensor, a gravity acceleration sensor may detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors such as a gyroscope, a barometer, a hygrometer, a thermometer, and an infrared sensor, which may be configured in the mobile terminal 800, are not described in detail herein.

The audio circuit 160, a speaker 161, and a microphone 162 may provide audio interfaces between the user and the mobile terminal 800. The audio circuit 160 may convert received audio data into an electric signal and transmit the electric signal to the speaker 161. The speaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another mobile terminal by using the RF circuit 110, or outputs the audio data to the memory 120 for further processing. The audio circuit 160 may further include an earplug jack, so as to provide communication between a peripheral earphone and the mobile terminal 800.

WiFi is a short distance wireless transmission technology. The mobile terminal 800 may help, by using the WiFi module 170, the user to receive and send emails, browse a web page, access streaming media, and so on, which provides wireless broadband Internet access for the user.

The processor 180 is the control center of the mobile terminal 800, and is connected to various parts of the mobile terminal by using various interfaces and lines. By running or executing the software program and/or module stored in the memory 120, and invoking data stored in the memory 120, the processor 180 performs various functions and data processing of the mobile terminal 800, thereby performing overall monitoring on the mobile terminal. In some embodiments, the processor 180 may include the one or more processing cores. In some embodiments, the processor 180 may integrate an application processor and a modem processor. The application processor mainly processes an operating system, a user interface, an application program, and the like. The modem processor mainly processes wireless communication. It may be understood that the foregoing modem processor may be not integrated into the processor 180.

The mobile terminal 800 further includes the power supply 190 (such as a battery) for supplying power to the components. In some embodiments, the power supply may be logically connected to the processor 180 by using a power management system, thereby implementing functions, such as charging, discharging, and power consumption management, by using the power management system. The power supply 190 may further include one or more of a direct current or alternating current power supply, a re-charging system, a power failure detection circuit, a power supply converter or inverter, a power supply state indicator, and any other components.

Although not shown in the figure, the mobile terminal 800 may further include a camera, a Bluetooth module, and the like, which are not described in detail herein. Specifically, in this exemplary embodiment, the display unit of the mobile terminal is a touch display screen, and the mobile terminal further includes a memory and one or more programs. The one or more programs are stored in the memory, and the one or more programs are configured to be performed by one or more processors. The one or more programs include an instruction applied to the information recommendation method of the mobile terminal, so that the processor can perform a corresponding information recommendation operation by accessing the program stored in the memory.

According to the mobile terminal provided in this exemplary embodiment of the present disclosure, after obtaining ticket booking information that is input by a user in a ticket booking process, a mobile terminal actively generates a tour route obtaining request according to the ticket booking information and identifier information of a to-be-visited spot, and sends the tour route obtaining request to an information exchange server; and the information exchange server sends a tour route matching the user to the mobile terminal according to the tour route obtaining request, to recommend the tour route to the user. Such a visiting manner is more intelligent, reduces time costs and complexity when the user actively queries for the tour route, and further can prevent the user from missing some popular scenic spots or landmarks. In addition, besides recommending the tour route to the user, map guide in the visited spot and an audio commentary service for the scenic spot can further be provided. Therefore, such an information recommendation manner is more diversified and brings great convenience to the user, so that tour experience of the user is better.

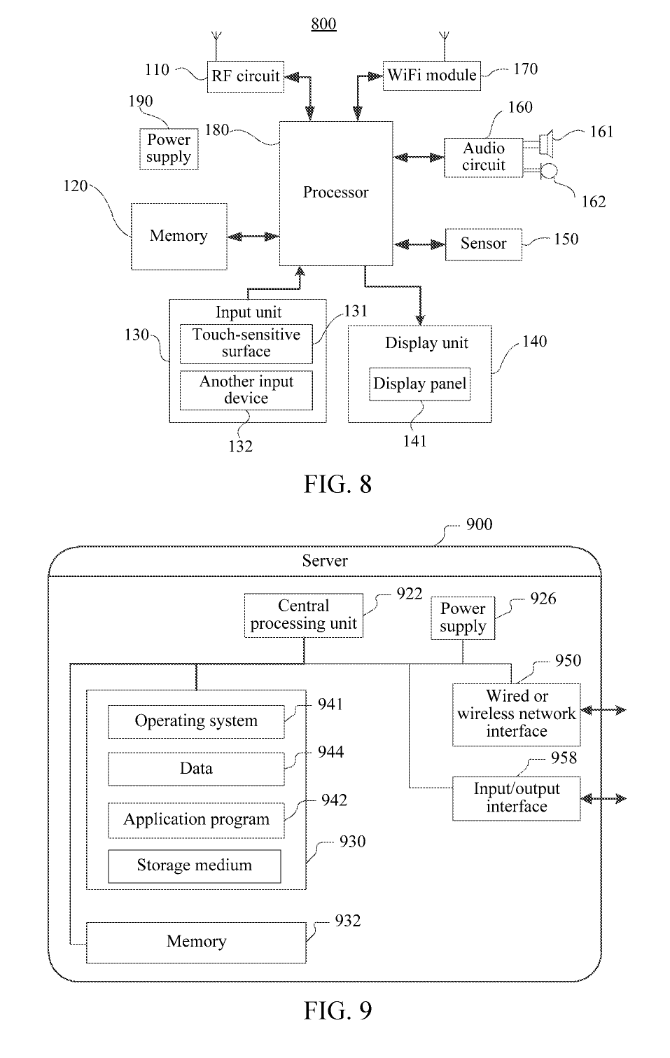

FIG. 9 shows a server according to an exemplary embodiment. The server may be configured to implement the information recommendation method performed by an information exchange server and shown in any one of the foregoing exemplary embodiments. Specifically, referring to FIG. 9, the server 900 may vary greatly due to different configurations or performance, and may include one or more central processing units (CPUs) 922 (for example, one or more processors), a memory 932, and one or more storage mediums 930 (for example, one or more mass storage devices) that store an application program 942 or data 944. The memory 932 and the storage medium 930 may be transient or persistent storages. A program stored in the storage medium 930 may include one or more modules (not shown).

The server 900 may further include one or more power supplies 926, one or more wired or wireless network interfaces 950, one or more input/output interfaces 958, and/or one or more operating systems 941, for example, Windows Server™, Mac OS X™, Unix™, Linux™, or FreeBSD™. One or more programs are stored in the memory, and the one or more programs are configured to be performed by one or more processors. The one or more programs include an instruction applied to the information recommendation method of the information exchange server, so that the processor may perform a corresponding information recommendation operation by accessing a program stored in the memory.

A person of ordinary skill in the art may understand that all or some of the steps of the exemplary embodiments may be implemented by hardware or a program instructing related hardware. The program may be stored in a computer-readable storage medium. The storage medium may include: a read-only memory, a magnetic disk, or an optical disc.

The foregoing descriptions are merely exemplary embodiments of the present disclosure, but are not intended to limit the present disclosure. Any modification, equivalent replacement, and improvement made without departing from the spirit and principle of the present disclosure shall fall within the protection scope of the present disclosure.

What is claimed is:

1. An information recommendation method performed at a mobile terminal that is communicatively connected to an information exchange server and also to a public identifier server via the information exchange server, the method comprising:
obtaining input ticket booking information, the ticket booking information comprising at least a ticket type and a ticket quantity;
generating a tour route obtaining request according to the ticket booking information and identifier information of a to-be-visited spot;
sending the tour route obtaining request and a user identifier of a user of the mobile terminal to the information exchange server; and
receiving a specified tour route, which is from the public identifier server and sent by the information exchange server based on the user identifier, and which matches the tour route obtaining request, and displaying the specified tour route on the mobile terminal.

2. The method according to claim 1, wherein before the obtaining input ticket booking information, the method further comprises:
sending an access request for a ticket booking link to the information exchange server, wherein the ticket booking link is obtained by scanning a graphic code of the to-be-visited spot by the mobile terminal; and
receiving web page information sent by the information exchange server and corresponding to the ticket booking link, and displaying a ticket booking page based on the web page information.

3. The method according to claim 1, wherein before the obtaining input ticket booking information, the method further comprises:
after detecting an operation of selecting a ticket booking menu option on a first information exchange page, sending an access request for a ticket booking link to the information exchange server, wherein the first information exchange page is a page related to the to-be-visited spot and comprising multiple levels of menu options; and
receiving web page information sent by the information exchange server and corresponding to the ticket booking link, and displaying a ticket booking page based on the web page information.

4. The method according to claim 1, wherein before the obtaining input ticket booking information, the method further comprises:
after detecting an operation of tapping a ticket booking link on a second information exchange page, sending an access request for the ticket booking link to the information exchange server, wherein the second information exchange page is a page on which the user exchanges information with a different user; and
receiving web page information sent by the information exchange server and corresponding to the ticket booking link, and displaying a ticket booking page based on the web page information.

5. The method according to claim 1, wherein after the obtaining input ticket booking information, the method further comprises:
sending a map data obtaining request to the information exchange server, wherein the map data obtaining request comprises at least the identifier information of the to-be-visited spot;
receiving map data, which is from the public identifier server, and which is sent by the information exchange server and matching the to-be-visited spot; and
after detecting a map guide operation that is performed by the user by using an information exchange application, displaying map information in a preset geographic range on a map interface based on the map data and a current geographic location of the user.

6. The method according to claim 5, wherein the map interface comprises a plurality of interest filtering options, and the displaying map information in a preset geographic range on a map interface comprises:
after detecting an operation of selecting one of the interest filtering options, displaying, on the map interface, at least one point of interest that is in the preset geographic range and that matches the selected one of the interest filtering options; and
after detecting an operation of selecting any one of the at least one point of interest, displaying detailed description information and navigation information of a path to the any one of the at least one point of interest.

7. The method according to claim 1, wherein after the obtaining input ticket booking information, the method further comprises:
after detecting an audio commentary operation that is performed by the user by using an information exchange application, displaying, on a first information exchange page, introduction information of an audio commentary matching the to-be-visited spot;
after receiving an audio commentary request of the user for any point of interest in the to-be-visited spot, sending an audio commentary obtaining request to the information exchange server, wherein the audio commentary obtaining request comprises at least identifier information of the point of interest; and
receiving an audio commentary sent by the information exchange server and matching the point of interest, and broadcasting the audio commentary.

8. A mobile terminal that is communicatively connected to an information exchange server and also to a public identifier server via the information exchange server, the mobile terminal comprising:
one or more processors;
memory coupled to the one or more processors; and
a plurality of executable instructions stored in the memory, wherein the executable instructions, when executed by the one or more processors, cause the mobile terminal to perform the following operations:
obtaining input ticket booking information, the ticket booking information comprising at least a ticket type and a ticket quantity;
generating a tour route obtaining request according to the ticket booking information and identifier information of a to-be-visited spot;
sending the tour route obtaining request and a user identifier of a user of the mobile terminal to the information exchange server; and
receiving a specified tour route, which is from the public identifier server and is sent by the information exchange server based on the user identifier, and which matches the tour route obtaining request, and displaying the specified tour route on the mobile terminal.

9. The mobile terminal according to claim 8, wherein before the obtaining input ticket booking information, the operations further comprise:
sending an access request for a ticket booking link to the information exchange server, wherein the ticket booking link is obtained by scanning a graphic code of the to-be-visited spot by the mobile terminal; and
receiving web page information sent by the information exchange server and corresponding to the ticket booking link, and displaying a ticket booking page based on the web page information.

10. The mobile terminal according to claim 8, wherein before the obtaining input ticket booking information, the operations further comprise:
after detecting an operation of selecting a ticket booking menu option on a first information exchange page, sending an access request for a ticket booking link to the information exchange server, wherein the first information exchange page is a page related to the to-be-visited spot and comprising multiple levels of menu options; and
receiving web page information sent by the information exchange server and corresponding to the ticket booking link, and displaying a ticket booking page based on the web page information.

11. The mobile terminal according to claim 8, wherein before the obtaining input ticket booking information, the operations further comprise:
after detecting an operation of tapping a ticket booking link on a second information exchange page, sending an access request for the ticket booking link to the information exchange server, wherein the second information exchange page is a page on which the user exchanges information with a different user; and
receiving web page information sent by the information exchange server and corresponding to the ticket booking link, and displaying a ticket booking page based on the web page information.

12. The mobile terminal according to claim 8, wherein after the obtaining input ticket booking information, the operations further comprise:
sending a map data obtaining request to the information exchange server, wherein the map data obtaining request comprises at least the identifier information of the to-be-visited spot;
receiving map data, which is from the public identifier server, and which is sent by the information exchange server and matching the to-be-visited spot; and
after detecting a map guide operation that is performed by the user by using an information exchange application, displaying map information in a preset geographic range on a map interface based on the map data and a current geographic location of the user.

13. The mobile terminal according to claim 12, wherein the map interface comprises a plurality of interest filtering options, and the displaying map information in a preset geographic range on a map interface comprises:
after detecting an operation of selecting one of the interest filtering options, displaying, on the map interface, at least one point of interest that is in the preset geographic range and that matches the selected one of the interest filtering options; and
after detecting an operation of selecting any one of the at least one point of interest, displaying detailed description information and navigation information of a path to the any one of the at least one point of interest.

14. The mobile terminal according to claim 8, wherein after the obtaining input ticket booking information, the operations further comprise:
after detecting an audio commentary operation that is performed by the user by using an information exchange application, displaying, on a first information exchange page, introduction information of an audio commentary matching the to-be-visited spot;
after receiving an audio commentary request of the user for any point of interest in the to-be-visited spot, sending an audio commentary obtaining request to the information exchange server, wherein the audio commentary obtaining request comprises at least identifier information of the point of interest; and
receiving an audio commentary sent by the information exchange server and matching the point of interest, and broadcasting the audio commentary.

15. A non-transitory computer readable storage medium storing a plurality of executable instructions configured for execution by one or more processors of a mobile terminal that is communicatively connected to an information exchange server and also to a public identifier server via the information exchange server, wherein the plurality of instructions, when executed by the one or more processors, cause the mobile terminal to perform the following operations:
obtaining input ticket booking information, the ticket booking information comprising at least a ticket type and a ticket quantity;
generating a tour route obtaining request according to the ticket booking information and identifier information of a to-be-visited spot;
sending the tour route obtaining request and a user identifier of a user of the mobile terminal to the information exchange server; and
receiving a specified tour route, which is from the public identifier server and is sent by the information exchange server based on the user identifier, and which matches the tour route obtaining request, and displaying the specified tour route on the mobile terminal.

16. The non-transitory computer readable storage medium according to claim 15, wherein before the obtaining input ticket booking information, the operations further comprise:
sending an access request for a ticket booking link to the information exchange server, wherein the ticket booking link is obtained by scanning a graphic code of the to-be-visited spot by the mobile terminal; and
receiving web page information sent by the information exchange server and corresponding to the ticket booking link, and displaying a ticket booking page based on the web page information.

17. The non-transitory computer readable storage medium according to claim 15, wherein before the obtaining input ticket booking information, the operations further comprise:
after detecting an operation of selecting a ticket booking menu option on a first information exchange page, sending an access request for a ticket booking link to the information exchange server, wherein the first information exchange page is a page related to the to-be-visited spot and comprising multiple levels of menu options; and
receiving web page information sent by the information exchange server and corresponding to the ticket booking link, and displaying a ticket booking page based on the web page information.

18. The non-transitory computer readable storage medium according to claim 15, wherein before the obtaining input ticket booking information, the operations further comprise:
after detecting an operation of tapping a ticket booking link on a second information exchange page, sending an access request for the ticket booking link to the information exchange server, wherein the second information exchange page is a page on which the user exchanges information with a different user; and
receiving web page information sent by the information exchange server and corresponding to the ticket booking link, and displaying a ticket booking page based on the web page information.

19. The non-transitory computer readable storage medium according to claim 15, wherein after the obtaining input ticket booking information, the operations further comprise:
sending a map data obtaining request to the information exchange server, wherein the map data obtaining request comprises at least the identifier information of the to-be-visited spot;
receiving map data, which is from the public identifier server, and which is sent by the information exchange server and matching the to-be-visited spot; and
after detecting a map guide operation that is performed by the user by using an information exchange application, displaying map information in a preset geographic range on a map interface based on the map data and a current geographic location of the user.

20. The non-transitory computer readable storage medium according to claim 19, wherein the map interface comprises a plurality of interest filtering options, and the displaying map information in a preset geographic range on a map interface comprises:
after detecting an operation of selecting one of the interest filtering options, displaying, on the map interface, at least one point of interest that is in the preset geographic range and that matches the selected one of the interest filtering options; and
after detecting an operation of selecting any one of the at least one point of interest, displaying detailed description information and navigation information of a path to the any one of the at least one point of interest.
